(19) United States
(12) Patent Application Publication
(10) Pub. No.: US 2025/0316795 A1
(43) Pub. Date: Oct. 9, 2025

(54) HIGH HEAT CAPACITY MATERIALS FOR IMPROVED SAFETY OF HIGH ENERGY DENSITY BATTERIES

(71) Applicant: ENEVATE CORPORATION, Irvine, CA (US)

(72) Inventors: Daniel Sylvinson Muthiah Ravinson, Irvine, CA (US); Mya Le Thai, Irvine, CA (US); Qing Zhang, Irvine, CA (US); Benjamin Yong Park, Irvine, CA (US)

(21) Appl. No.: 18/990,362

(22) Filed: Dec. 20, 2024

Related U.S. Application Data
(60) Provisional application No. 63/575,185, filed on Apr. 5, 2024.
(60) Provisional application No. 63/575,200, filed on Apr. 5, 2024.

(51) Int. Cl. H01M 10/659; H01M 4/02; H01M 4/62; H01M 10/0525; H01M 10/054

(52) U.S. Cl. CPC H01M 10/659; H01M 4/625; H01M 10/0525; H01M 10/054; H01M 2004/027

(57) ABSTRACT

This disclosure describes designs for improving the safety profile of a Li-ion, Na-ion or other electrochemical device. These designs improve heat capacity and reduce or delay the triggering of thermal runaway in addition to reducing the temperature rise during thermal runaway.

### CROSS-REFERENCE TO RELATED APPLICATIONS

This application claims the benefit of and priority to U.S. Provisional Patent Application No. 63/575,115, titled “CELLS WITH INSULATION PAPER WRAPPING FOR DELAYED HEAT PROPAGATION,” filed Apr. 5, 2024. This application also claims the benefit of and priority to U.S. Provisional Patent Application No. 63/575,185, titled “HIGH HEAT CAPACITY MATERIALS FOR IMPROVED SAFETY OF HIGH ENERGY DENSITY BATTERIES,” filed Apr. 5, 2024. This application also claims the benefit of and priority to U.S. Provisional Patent Application No. 63/575,200, titled “SAFETY-ENHANCEMENT STATE-OF-CHARGE (SOC) REDUCTION DEVICES FOR PROPAGATION RESISTANT LITHIUM-ION BATTERIES,” filed Apr. 5, 2024. Each of these disclosures are incorporated herein by reference in their entirety.

### BACKGROUND

Limitations and disadvantages of traditional materials will become apparent to one of skill in the art, through comparison of such approaches with some aspects of the present method and system set forth in the remainder of this disclosure with reference to the drawings.

### BRIEF SUMMARY

High heat capacity materials for improved safety of high energy density batteries, substantially as illustrated by and/or described in connection with at least one of the figures, as set forth more completely in the claims.

### BRIEF DESCRIPTION OF THE DRAWINGS

FIG. 1 illustrates specific heat capacity of graphite and silicon as a function of temperature, in accordance with various example implementations of this disclosure.

FIGS. 2A, 2B and 2C illustrate the cumulative heat absorbed by cells with various anode compositions, in accordance with various example implementations of this disclosure.

FIGS. 3-6 illustrate example batteries with anode variations, in accordance with various example implementations of this disclosure.

FIG. 7 illustrates an example thermal propagation test setup, in accordance with various example implementations of this disclosure.

FIGS. 8A and 8B illustrate example remains of cells after thermal propagation testing, in accordance with various example implementations of this disclosure.

FIG. 9 illustrates an example battery management system (BMS) for use in managing operation of batteries, in accordance with various example implementations of this disclosure.

FIG. 10 is a flow diagram of an example lamination process for forming a silicon-dominant anode cell, in accordance with various example implementations of this disclosure.

FIG. 11 is a flow diagram of a direct coating process for forming a silicon-dominant anode cell, in accordance with an example embodiment of the disclosure.

### DETAILED DESCRIPTION

While the technology herein is often described as being incorporated into silicon batteries, the technology also applies to traditional non-silicon batteries and their manufacturing processes.

### Thermal Propagation

Lithium-ion battery (LIB) cells are commonly used in power tools, e-bikes, and electric vehicles. However, these batteries can sometimes malfunction, with thermal runaway (TR) being one possible failure mode. TR is a chain reaction that involves a rapid rise in cell temperature, cell rupture, decomposition and explosion due to gas release and uncontrolled fire. Such failures can result from mechanical impacts, foreign material penetration, or defects in electrical, thermal, or manufacturing processes. LIB cells have a limited tolerance for deviations from their specified temperature and voltage/current ranges. When these parameters are exceeded, it can cause overcharging and increase the risk of TR. Additionally, if a cell is damaged by debris during an accident, it might also enter a TR state.

TR in a single cell can quickly spread to adjacent cells, especially in large packs used in e-mobility or energy storage systems. This is referred to as thermal propagation (TP). For instance, TP within a vehicle's battery pack could jeopardize the entire vehicle and endanger the occupants. In cells with higher energy densities, such as those containing silicon or lithium metal, the safety concerns are more pronounced. These cells heat up more rapidly due to their lower heat capacity compared to traditional graphite or nickel-based cells. High-nickel cathodes like NMC622, NMC811, NCMA and NCA can exacerbate the issue by releasing oxygen, which accelerates TR.

TP can lead to significant property damage, injury, or even loss of life. This disclosure provides better safety, by reducing the risk of or preventing TP at the pack level and TR at the cell level.

### High Heat Capacity Materials

The present disclosure improves the safety profile of electrochemical devices by incorporating materials with high specific heat capacity, materials that undergo endothermic phase changes or reactions or combinations thereof, into various components of the cell. These materials absorb significant amounts of heat during normal operation and, more critically, during thermal events, thereby reducing the rate and extent of temperature increases.

Specific heat capacity is the amount of heat required per unit mass to raise the temperature of one-degree Celsius. Specific heat capacity may be measured in joules per kilogram per Kelvin (J/(kg·K)) or joules per gram per Kelvin (J/(g·K)). A change in temperature of one-degree Celsius is equivalent to a change in temperature of one-degree Kelvin. Specific heat capacity in joules per kilogram per Kelvin (J/(kg·K)) is 1000 times the specific heat capacity in joules per gram per Kelvin (J/(g·K)).

Silicon-based LIB cells have a lower heat capacity than conventional graphite-based LIB cells. A lower heat capacity means that less heat is needed to raise the temperature of the silicon-based LIB cells to the TR trigger temperature, making it easier to initiate TR. A lower heat capacity also means that the silicon-based LIB cells experience a faster and higher temperature rise.

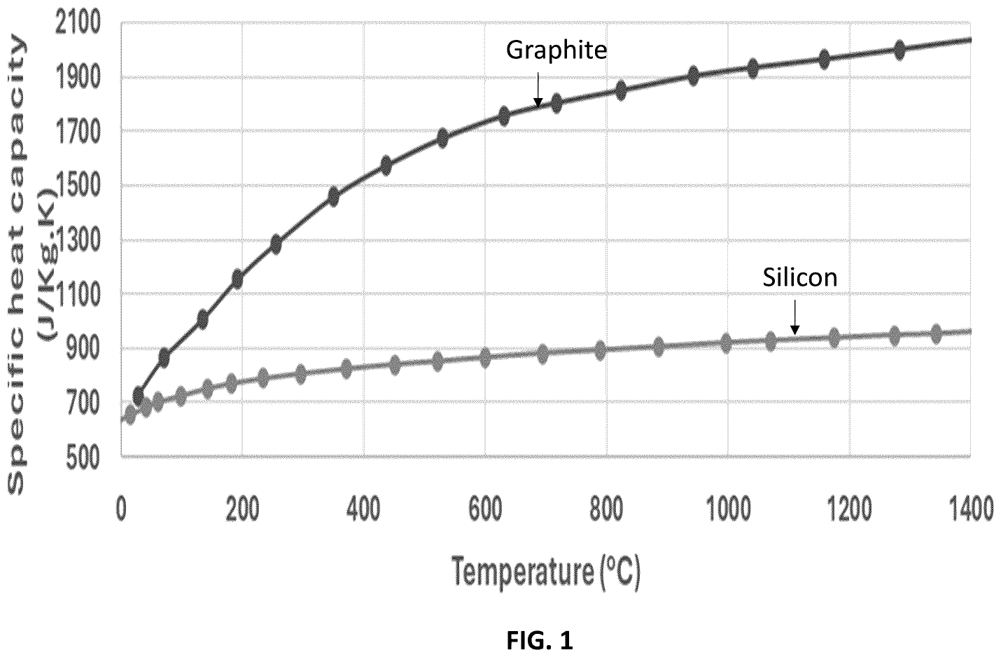

FIG. 1 illustrates specific heat capacity of graphite and silicon as a function of temperature, in accordance with various example implementations of this disclosure.

As seen in FIG. 1, the specific heat capacity of graphite has a very steep temperature dependence relative to silicon and while both materials have similar specific heat capacities at room temperature, the specific heat capacity of graphite reaches roughly twice that of silicon around 1000° C. These differences at the materials level can lead to drastic differences in TR behavior between Gr and Si cells.

To reduce the TR trigger temperature, this disclosure incorporates materials with a specific heat capacity greater than 1 J/g·K, with preferred embodiments utilizing materials with specific heat capacities greater than 1.5, 2.0, and ideally greater than 2.5 J/g·K at room temperature and ambient pressure. While this disclosure describes examples of integrating materials into an anode, these materials may also be integrated into any component of an electrochemical cell, including but not limited to the electrodes, separator, electrolyte and casing. For Ni-based cathodes which exhibit large exothermic reactions during TR, it may be even more beneficial to incorporate these additives in the cathode.

By increasing the overall heat absorption capacity of the cell, these materials help to mitigate temperature rises during normal and abnormal operation, thereby reducing the likelihood of TR.

This disclosure describes designs for improving the safety profile of a Li-ion, Na-ion or other electrochemical device. These designs improve heat capacity and reduce or delay the triggering of TR in addition to reducing the rate and temperature rise during TR to reduce/eliminate flammability.

The disclosed battery devices comprise a cell and a high heat capacity material incorporated into the cell. The total added weight of the high heat capacity material is less than 20% of a weight of the cell. Alternatively, the total added weight of the high heat capacity material is less than 15%, 10% or 5% of a weight of the cell. The cell may be a lithium ion cell or a sodium ion cell.

The material may be operable to undergo endothermic phase changes and/or endothermic phase reactions. The endothermic enthalpy of the material may be greater than 500 J/g (alternatively, greater than 750 J/g or 1,000 J/g). The material may have a heat absorption capacity of at least 2,000 J/g (alternatively at least 3000 J/g, 4000 J/g, 5000 J/g, 6000 J/g, 7000 J/g or 8000 J/g) at a temperature between 25° C. and 1000° C.

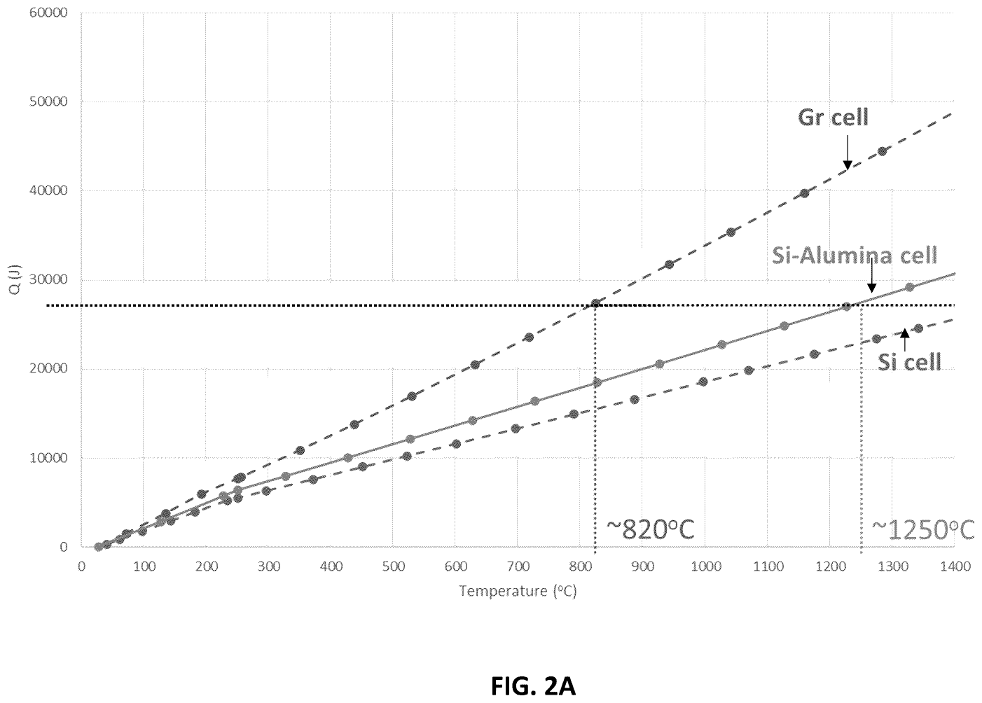

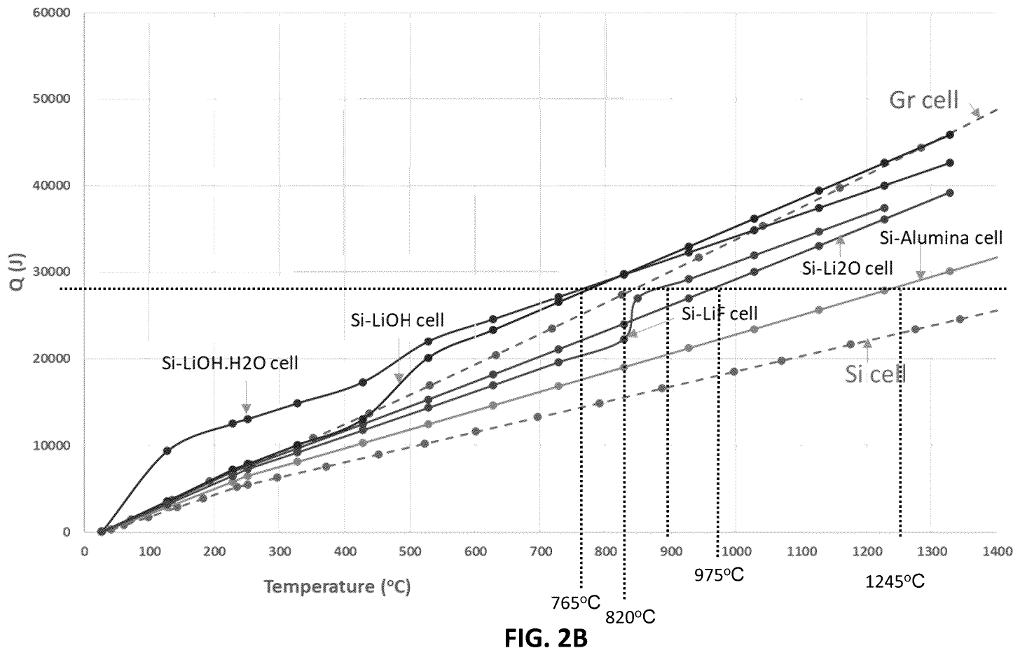

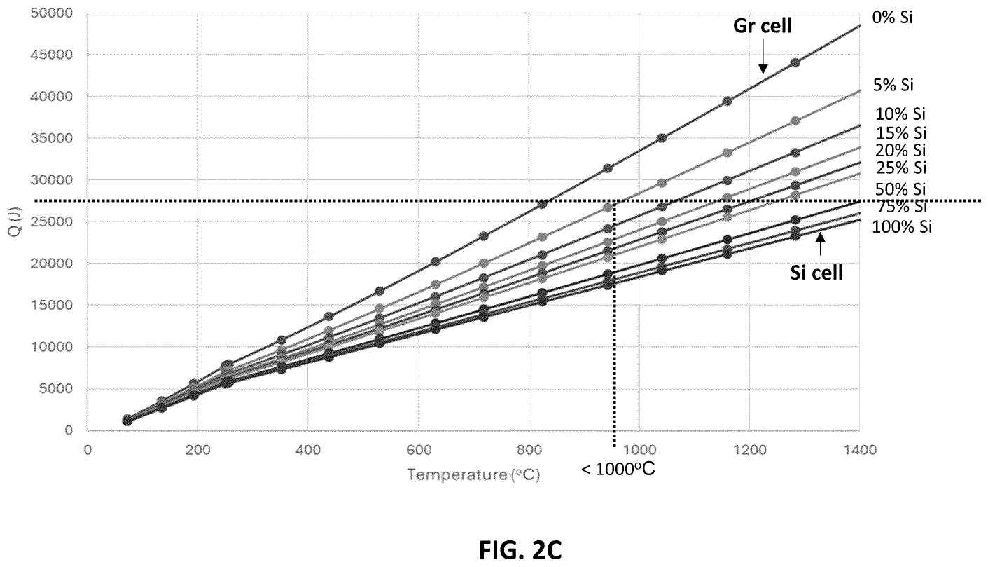

As described with reference to FIGS. 2A and 2B below, Al2O3 may be added to a LIB cell. As described with reference to FIG. 2B below, LiF, Li₂O, LiOH and LiOH·H2O may be added to a LIB cell. Additionally Li2CO3, Mg(OH)2, Al(OH)3, LiAlO2, LiAlF4 and/or a Lithium/Beryllium compound (e.g., BeO, BeF2, Be(OH)2) may also be incorporated into the cell.

As described with reference to FIG. 2C, the cell may also incorporate additional graphite or amorphous hard/soft carbon, expandable graphite, expanded graphite, graphene, fullerenes, carbon nanotubes (SWCNT/MWCNT), carbon fibers, carbon-carbon composites, or any other carbon allotropes. For example, anodes may comprise graphite (Gr), silicon (e.g., Si or SiOx) and/or lithium (Li) metal to improve heat capacity and therefore reduce ease of triggering TR in addition to reducing rate and temperature rise during TR.

The battery device may incorporate nonflammable/flame retardant electrolyte components with high specific heat capacity and/or high boiling point and/or enthalpy of vaporization including but not limited to any combination of Phosphazenes, ionic liquids, phosphite/phosphate-based solvents like TMP (Trimethyl phosphate), TEP(Triethyl phosphate), TFEP (tris(2,2,2-trifluoroethyl) phosphate), etc,, high boiling point hydroflouroethers like (1,1,2,2-Tetrafluoroethyl-2,2,3,3-tetrafluoropropyl ether, 1,1,2,2-Tetrafluoroethyl-1H, 1H,5H-octafluoropentyl ether, Novec-7300, 7500, etc.,), perfluoroethers, perfluorocarbon solvents, hydrofluorocarbon solvents etc.

The battery device may incorporate nonflammable/low flammability polymers with high specific heat capacity like Teflon (PTFE), PVDF. PVC, Polyvinylidene chloride, etc.

The battery device may incorporate polymers/waxes with high specific heat capacity like rubbers, paraffin waxes, hydrofluorowaxes, fluorinated paraffins, lignins, furfurals, phenolic resins, epoxy resins, cellulose-based polymers, PET, polyamides, polyimides, PVA, PEEK, PEO, PEG, aramids, polycarbonates, polyethylenes, polyarylacetylene, polystyrenes, PAN, PMMA, polypropylenes, silicones, Teflon, PVDF. PVC, Polyvinylidene chloride, etc. along with flame retardant additives like APP (Ammonium polyphosphate), triphenyl phosphate, brominated flame retardants, etc. to reduce/eliminate flammability.

To further enhance safety, this disclosure also comprises materials that undergo endothermic phase changes or reactions within the cell components. These materials exhibit endothermic enthalpies greater than 500 J/g, with alternative embodiments utilizing materials with endothermic enthalpies greater than 750 J/g and 1000 J/g. The incorporation of these materials allows the cell to absorb even more heat during thermal events, providing a critical buffer against TP.

In another embodiment, materials are selected that exhibit both high specific heat capacity and significant endothermic behavior. These materials may exhibit a steep increase in specific heat capacity (1-4 J/kg·K²) with rising temperature, or they may undergo endothermic reactions or phase changes. The overall heat absorption capability of the cell is thereby significantly enhanced, potentially reaching levels greater than 2000 J/g, with alternative embodiments achieving levels greater than 3000, 4000, 5000, 6000, 7000, or even 8000 J/g over a temperature range between 25° C. and 1000° C.

FIG. 2A illustrates the cumulative heat (denoted as Q(J)) absorbed by cells having anodes loaded with graphite, silicon and silicon-alumina as provided in Table 1 below:

TABLE 1
Design parameters of different NCM811 cells that were subjected to TP tests

| Cell | | Anode | | | |
|---|---|---|---|---|---|
| design | | Loading | | TR max. | Heat |
| (13-layer | Anode Formulation | (mg/cm² | Capacity | temp. | Capacity |
| pouch) | (on 15 m copper foil) | per side) | (mAh) | (° C.) | (J/K) |
| Graphite | 95.4% graphite | 18 | 2200 | 820 | 33.12 |
| | 4.6% polymer | | | | |
| Si | 95.4% m-sized Silicon | 3.53 | 2200 | >1400 | 25.36 |
| | 4.6% Pyrolytic carbon | | | | |
| Si- | 35.4% m-sized Silicon | 9.66 | 2200 | 1245 | 27.95 |
| Alumina | 60% Alumina | | | | |
| | 4.6% Pyrolytic carbon | | | | |

Under adiabatic conditions with identical components except for the anodes, FIG. 2A illustrates that for the same amount of heat needed to raise the graphite cell from room temperature to ˜820° C., the equivalent Si cell reaches temperatures in excess of 1400° C. This is due to the Gr cell starting off with a ˜30% higher heat capacity compared to the equivalent Si cell at room temperature (driven by the lower gravimetric energy density of the Gr cell) but amplified by the steeper temperature dependence.

When 5.8 mg/cm2 of alumina (Al₂O₃) is added to the Si anode to improve the heat capacity, the max temperature recorded during the TP test was reduced to ˜1250° C.

FIG. 2B illustrates the cumulative heat absorbed by cells having anodes loaded with different additives as provided in Table 2:

TABLE 2
Design parameters of different NCM811
cells with different anode additives

| | | | TR max. | |
|---|---|---|---|---|
| | Anode Loading | | temp. | |
| Anode | (mg/cm² per | Capacity | (modelled) | Density |
| Additive | side) | (mAh) | (° C.) | (g/cc) |
| Al2O3 | 7 | 2200 | 1245 | 3.99 |
| (Alumina) | | | | |
| Li2O | 7 | 2200 | 975 | 2.01 |
| LiOH•H2O | 7 | 2200 | 765 | 1.51 |
| LiOH | 7 | 2200 | 765 | 1.46 |
| LiF | 7 | 2200 | 900 | 2.64 |

The additives as provided in Table 2 have even higher specific heat capacities than graphite at room temperature and still exhibit a steep temperature dependence. These materials do not hamper the operation of the cell and remain electrochemically inert during normal operation of the cell. These materials also possess a high density, which minimizes volumetric energy density loss incurred by their incorporation. As shown in FIG. 2B, these materials do not volatize or sublime under 1000° C., which means that the materials will remain within the cell across the temperature range experienced by the cell during TR. These materials should not react with other materials or react by itself to release heat in an exothermic reaction. These materials are easily processable, cost-effective and sustainably sourced.

Additionally, LiF and LiOH melt around 460° C. and 850° C. with substantially endothermic melting enthalpies of 972 J/g and 1,044 J/g respectively that can also contribute to the absorption of heat during TR and help lower temperature rise.

LiOH·H₂O may be advantageous for cells, such as LFP and low-Ni, whose temperature rise stays below 800° C. Beryllium-based compounds may be advantageous for scenarios where human exposure is not expected during operation.

This disclosure also provides for combinations of the aforementioned materials, particularly those with high heat capacity and nonflammable properties, wherein the total added weight of these materials is less than 20% of the total weight of the cell. Alternative embodiments may limit the added weight to less than 15%, 10%, or 5%.

FIG. 2C illustrates the effect Si content (as a percentage of weight) has on the heat absorption capability of cell designs with Si-Gr anodes designed to have the same capacity as the graphite cell defined in Table 1.

This disclosure benefits cell designs with high-energy density, such as those with anodes containing more than 5% silicon by weight. In such designs, the risk of TR is heightened due to the high temperatures that can be reached during operation. The incorporation of the proposed materials (described with respect to FIG. 2B) significantly mitigates this risk by enhancing the cell's ability to absorb and dissipate heat.

As shown in FIG. 2C, Si-Gr cell designs with only 10% Si by weight produce TR temperatures in excess of 1000° C. Therefore, the disclosure additives may be most useful for cell designs in which the anodes contain >5% Si (Alternative ranges: >10% Si, >15% Si, >20% Si, 25% Si). This also applies to any other high energy density cell design (e.g., anode-free Li metal cells, other high capacity alloy anodes: Ge, Aluminum, Boron, etc.).

### Example Batteries

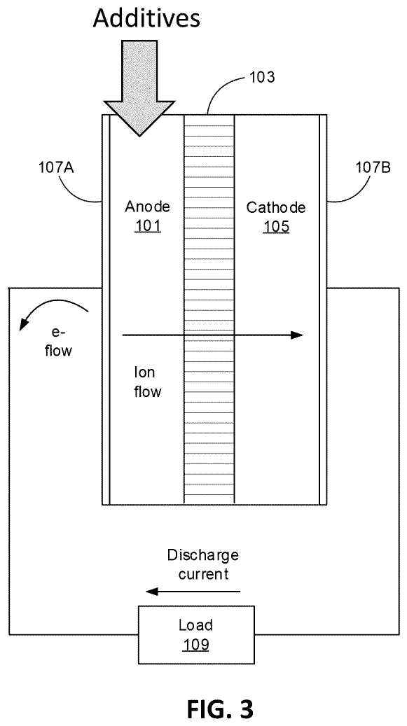

FIG. 3 illustrates an example battery with an anode variation. Referring to FIG. 3, there is shown a battery comprising a separator 103 sandwiched between an anode 101 and a cathode 105, with current collectors 107A and 107B. There is also shown a load 109 coupled to the battery illustrating instances when the battery is in discharge mode. In this disclosure, the term “battery” may be used to indicate a single electrochemical cell, a plurality of electrochemical cells formed into a module, and/or a plurality of modules formed into a pack. Furthermore, the battery shown in FIG. 3 is a very simplified example merely to show the principle of operation of a lithium-ion cell.

The development of portable electronic devices and electrification of transportation drive the need for high-performance electrochemical energy storage. In devices ranging from small-scale (<100 Wh) to large-scale (>10 kWh), LIBs are widely used over other rechargeable battery chemistries due to their advantages in energy density and cyclability.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

The configuration shown in FIG. 3 illustrates the battery in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. In this regard, different methods or processes may be used in forming electrodes, particularly silicon-dominant (>50% in terms of active material by capacity or by weight) anodes. For example, lamination or direct coating may be used in forming a silicon-containing anode (silicon anode). Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄, LiFSI, LiTFSI, etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more cyclic carbonates, such as ethylene carbonate (EC), fluoroethylene carbonate (FEC), or propylene carbonate (PC) as well as linear carbonates, such as ethyl methyl carbonate (EMC), diethyl carbonate (DEC), and dimethyl carbonate (DMC), in various percentages. In some embodiments, the electrolyte solvents may comprise one or more of EC from about 0-40%, FEC from about 2-40% and/or EMC from about 50-70% by weight.

The separator 103 may be soaked with a liquid or gel electrolyte. In addition, in an example embodiment, the separator 103 does not melt below about 100 to 140° C., and exhibits sufficient mechanical properties for battery applications. A battery, in operation, can experience expansion and contraction of the anode 101 and/or the cathode 105. In an example embodiment, the separator 103 can expand and contract by at least about 5 to 10% without tearing or otherwise failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery, providing electrical connections to the device for transfer of electrical charge in charge and discharge states. The anode 101 may comprise silicon, carbon, or combinations of these materials, for example. Typical anode electrodes comprise a carbon material and a current collector, such as a copper sheet. Carbon is often used because it has excellent electrochemical properties and is also electrically conductive. Anode electrodes currently used in rechargeable lithium-ion cells typically have a specific capacity of approximately 200 milliamp hours per gram (mAh/g). Graphite, the active material used in most lithium-ion battery anodes, has a theoretical energy density of 372 mAh/g. In comparison, silicon has a high theoretical capacity of 4200 mAh/g. In order to increase volumetric and gravimetric energy density of lithium-ion batteries, silicon may be used as the active material for the cathode 105 or anode 101. Si anodes may be in the form of a composite on a current collector, with >50% Si by capacity or weight in the composite layer.

In an example scenario, the anode 101 and cathode 105 store the ions used for separation of charge, such as lithium ions. In this example, the electrolyte carries positively charged lithium ions from the anode 101 to the cathode 105 in discharge mode, as shown in FIG. 3, and vice versa through the separator 103 in charge mode. The movement of the lithium ions and reactions with the electrodes create free electrons in one electrode which creates a charge at the opposite current collector. The electrical current then flows from the current collector where charge is created through the load 109 to the other current collector. The separator 103 blocks the flow of electrons inside the battery 100, allows the flow of lithium ions, and prevents direct contact between the electrodes.

While the battery is discharging and providing an electric current, the anode 101 releases lithium ions to the cathode 105 through the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current LIBs need to be improved in order to, for example, compete with internal combustion engine (ICE) technology and allow for the widespread adoption of electric vehicles (EVs). High energy density and high power density of LIBs are achieved with the development of high-capacity and high-voltage cathodes, high-capacity anodes and electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be improved by incorporating conductive additives with different morphological properties. Carbon black (Super P), vapor grown carbon fibers (VGCF), and a mixture of the two have previously been incorporated into the anode to improve electrical conductivity and otherwise improve performance. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). These contact points (especially when utilizing high-aspect-ratio conductive materials) facilitate the electrical contact between anode material and current collector to mitigate the isolation (island formation) of the electrode material while also improving conductivity in between silicon regions. Graphenes and carbon nanotubes may be used because they may show similar benefits. Thus, in some instances, a mixture of two or more of carbon black, vapor grown carbon fibers, graphene, and carbon nanotubes may be used independently or in combinations for the benefits of conductivity and other performance.

LIBs may employ a graphite-dominant anode which is a lithium intercalation type anode. Silicon-dominant anodes, however, may offer improvements compared to graphite-dominant Li-ion batteries. Silicon exhibits both higher gravimetric (4200 mAh/g vs. 372 mAh/g for graphite) and volumetric capacities (2194 mAh/cc vs. 890 mAh/cc for graphite). In addition, Si has a higher redox reaction potential versus Li compared to graphite, with a voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon anodes require a strong conductive matrix that (a) holds silicon particles together in the anode, (b) is flexible enough to accommodate the large volume expansion and contraction of silicon, and (c) allows a fast conduction of electrons within the matrix.

Therefore, there is a trade-off among the functions of active materials, conductive additives and polymer binders. The balance may be adversely impacted by high energy density silicon anodes with low conductivity and huge volume variations described above. Polymer binder(s) may be pyrolyzed to create a pyrolytic carbon matrix with embedded silicon particles. In addition, the polymers may be selected from polymers that are completely or partially soluble in water or other environmentally benign solvents or mixtures and combinations thereof. Polymer suspensions of materials that are non-soluble in water could also be utilized.

In some embodiments, dedicated systems and/or software may be used to control and manage batteries or packs thereof. In this regard, such dedicated systems may comprise suitable circuitry for running and/or executing control and manage related functions or operations. Further, such software may run on suitable circuitry, such as on processing circuitry (e.g., general processing units) already present in the systems or it may be implemented on dedicated hardware. For example, battery packs (e.g., those used in electric vehicles) may be equipped with a battery management system (BMS) for managing the batteries (or packs) and operations.

The additives described with respect to FIGS. 2A, 2B and 2C may be incorporated into the anode 101 of the cell by sideloading as shown in FIG. 3.

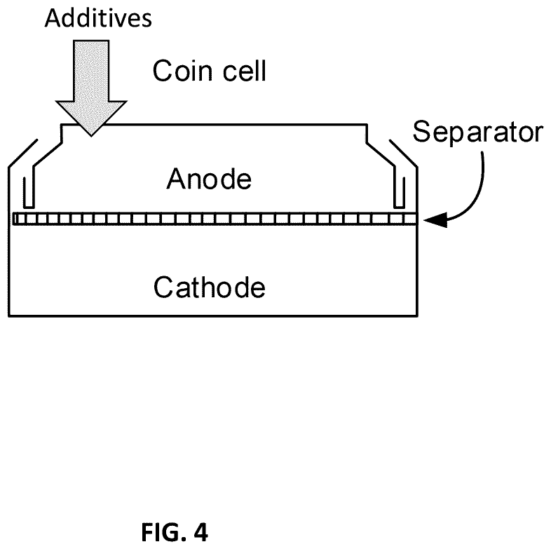

FIG. 4 illustrates an example SOCD coupled to a coin cell. The additives described with respect to FIGS. 2A, 2B and 2C may be incorporated into the anode of the cell by sideloading as shown in FIG. 4.

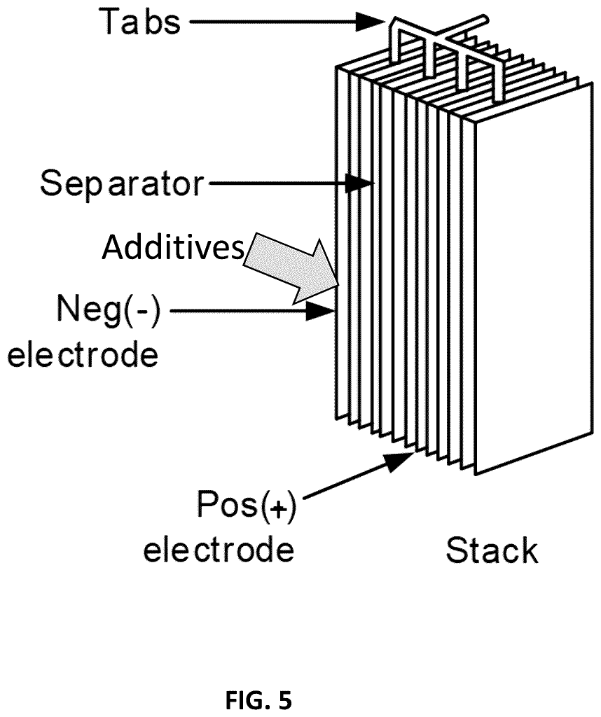

FIG. 5 illustrates an example SOCD coupled to a stack of electrodes. The additives described with respect to FIGS. 2A, 2B and 2C may be incorporated into the negative electrode of the cell by sideloading as shown in FIG. 5.

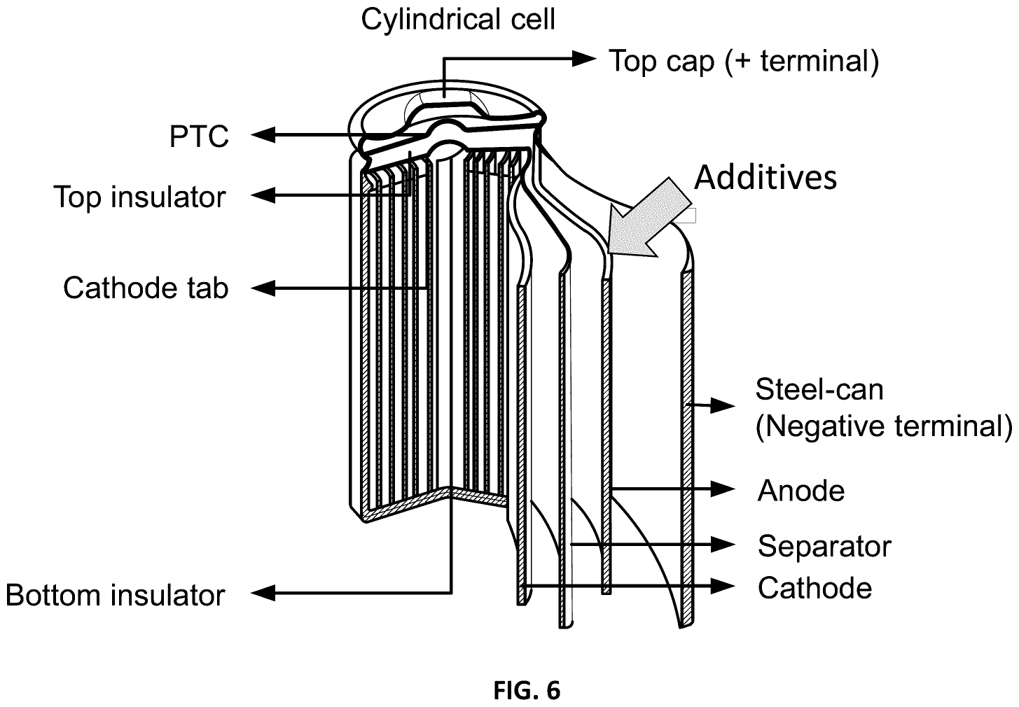

FIG. 6 illustrates an example SOCD coupled to a cylindrical metal can cell. The additives described with respect to FIGS. 2A, 2B and 2C may be incorporated into the anode of the cell by sideloading as shown in FIG. 6.

### TP Testing

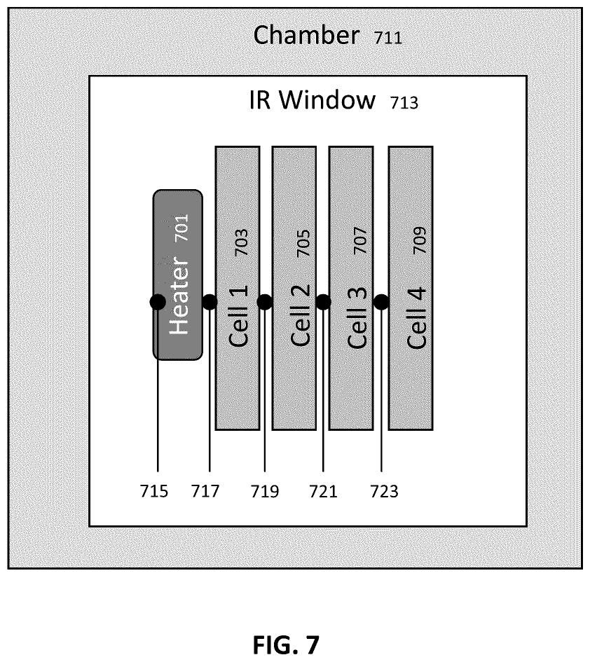

FIG. 7 illustrates an example TP test setup, in accordance with various implementations of this disclosure.

The TP test setup, shown in FIG. 7, includes a heater 701 and four pouch cells 703, 705, 707 and 709 within a heat-resistant ceramic chamber 711 equipped with an IR window 713.

During the TP test, a heater 701 (e.g., 200W heater) heats cell 1 703, while thermocouples 715, 717, 719, 721 and 723 measure the temperature of the heater 701 and the temperature changes between the cells 703, 705, 707 and 709. An IR sensor, installed through the IR window 713, provides accurate temperature and ignition timing measurements. The test is conducted in a controlled environment with a ceramic chamber 711 of approximately 1 cubic foot, featuring a tempered glass viewing window 713. Typically, four cells 703, 705, 707 and 709 are stacked with the top of one cell touching the bottom of the next. Only the bottom of the first cell 703 is directly on the heater 701. No external barriers are placed between the cells. The heater 701 covers 20% of the cells' area, with heating controlled to achieve a ramping rate of over 15° C./sec. A thermocouple 717 between the heater and the first cell 703 measures the heater's ramping rate to ensure it meets the design specifications. Key test outputs include the time required for TP and the maximum temperature reached by the cells.

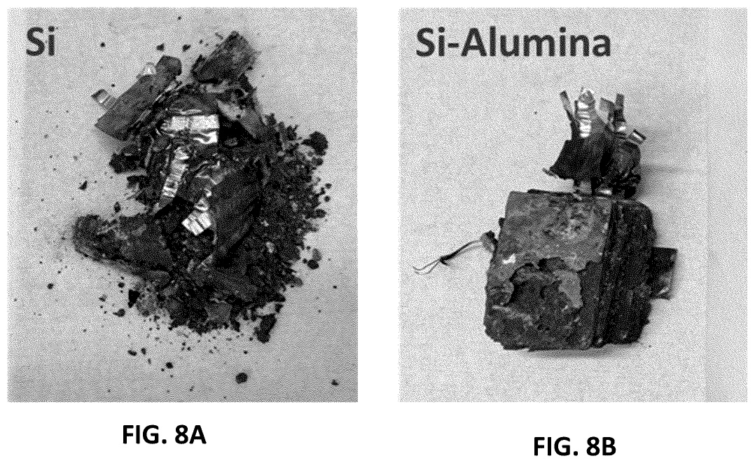

FIG. 8A illustrates an example of the remains of Si cells after TP.

FIG. 8B illustrates an example of the remains of Si-Alumina cells after TP.

As shown in FIG. 8B, the Si-Alumina cells after TP are mostly intact, while the pure Si cells (in FIG. 8A) are completely disintegrated. This disintegration indicates a more violent outcome due to the higher temperature rise.

As noted above, the temperature-dependent heat capacity of the cell design influences the temperature rise and rate of TR. Additionally, the heat capacity also impacts how easily TR can be triggered. This disclosure provides several strategies to improve the heat capacity of high energy density cells in order to reduce the propensity as well as severity of TR.

Combination with Additional Safety-Enhancement

Additional safety features may be included within a cell. All features may be enclosed within a cell enclosure (e.g., can or pouch or other). The present disclosure may be combined with other technologies such as state-of-charge device, electrolytes that are less flammable, electrolytes with high ionic conductive, high-temperature-resistant electrolytes and insulating layers.

Within a battery pack, different cells may incorporate varying technologies, such as alternating high heat capacity cells. The overall safety design may also depend on pack components like heat plates or foams, which might negate the need for internal insulating layers or higher heat capacity designs.

The safety features engineered in high energy density devices may comprise a total energy density higher than 600 Wh/L. The chemistry may comprise silicon. The anode may be silicon dominant. The chemistry may comprise a high nickel metal oxide with nickel equal or higher to that of NCM622. The cell may comprise both high nickel (cathode) and silicon (anode). The cell may comprise a lithium metal anode.

The safety devices implemented in cells may be built without significant interface materials being placed between them (cell-to-pack design). The safety devices may reduce the volumetric or gravimetric energy density of the cell by <30%, ideally <20%, <10% or <5%.

This disclosure enables high energy density chemistries such as silicon, lithium metal, high nickel cathodes, etc. This disclosure allows packs to be created in a more facile manner, by enclosing safety devices within the cell. This disclosure allows cell-to-pack designs with no significant interface between the cells, providing a higher pack energy density at a lower price. This disclosure does not require a complex design (e.g., with a semiconductor temperature sensor).

### Battery Management and Manufacturing

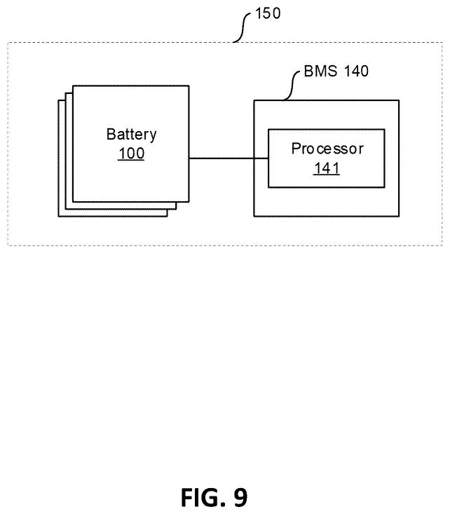

FIG. 9 illustrates an example battery management system (BMS) for use in managing operation of batteries. Shown in FIG. 9 is battery management system (BMS) 140.

The battery management system (BMS) 140 may comprise suitable circuitry (e.g., processor 141) configured to manage one or more batteries (e.g., each being an instance of the battery 100 as described with respect with FIG. 3). In this regard, the BMS 140 may be in communication and/or coupled with each battery 100. In some implementations, a separate processor (e.g., a conventional processor, such as an electronic control unit (ECU), a microcontroller unit (ECU), or the like), or several such separate processors, may be used, and may be configured to handle algorithms or control functions with regards to the batteries. In such implementations, such processor(s) may be connected to the batteries, such as through the processor 141, and thus may be treated as part of the BMS 140 and acting as part of processor 141.

In some embodiments, the battery 100 and the BMS 140 may be in communication and/or coupled with each other, for example, via electronics or wireless communication. In some embodiments, the BMS 140 may be incorporated into the battery 100. Alternatively, in some embodiments, the BMS 140 and the battery 100 may be combined into a common package 150. Further, in some embodiments, the BMS 140 and the battery 100 may be separate devices/components and may only be in communication with one another when present in the same system. The disclosure is not limited to any particular arrangement, however.

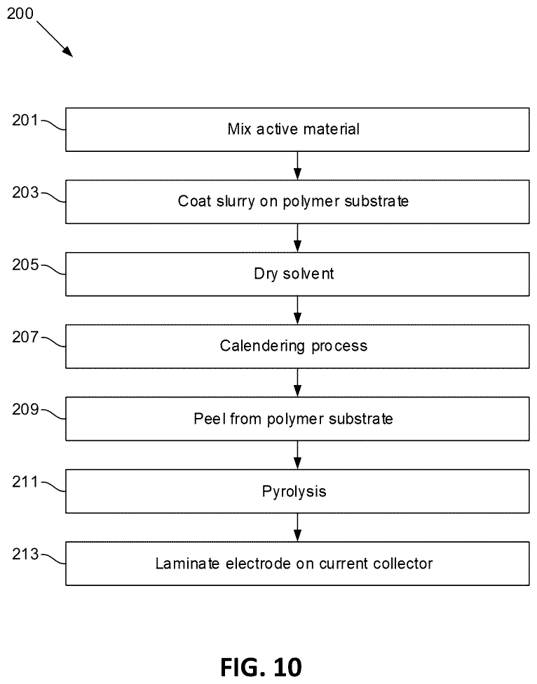

FIG. 10 is a flow diagram of an example lamination process for forming a silicon-dominant anode cell. This process employs a high-temperature pyrolysis process on a substrate, layer removal, and a lamination process to adhere the active material layer to a current collector. This strategy may also be adopted by other types of anodes, such as graphite, conversion type anodes, such as transition metal oxides, transition metal phosphides, and other alloy type anodes, such as Sn, Sb, Al, P, etc.

To fabricate an anode, the raw electrode active material is mixed in step 201. In the mixing process, the active material may be mixed with a binder/resin (such as water soluble PI (polyimide), PAI (polyamideimide), carboxymethyl cellulose (CMC), styrene-butadiene rubber (SBR), poly(acrylic acid) (PAA), Sodium Alginate, Phenolic or other water soluble resins and mixtures and combinations thereof), solvent, rheology modifiers, surfactants, pH modifiers, and conductive additives. The materials may comprise carbon nanotubes/fibers, graphene sheets, metal polymers, metals, semiconductors, and/or metal oxides, for example. Silicon powder with a 1-30 or 5-30 μm particle size, for example, may then be dispersed in polyamic acid resin, PAI, or PI (15-25% solids in N-Methyl pyrrolidone (NMP) or deionized (DI) water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%. The pH of the slurry can be varied from acidic to basic, which may be beneficial for controlling the solubility, conformation, or adhesion behavior of water soluble polyelectrolytes, such as polyamic acid, carboxymethyl cellulose, or polyacrylic acid. Ionic or non-ionic surfactants may be added to facilitate the wetting of the insoluble components of the slurry or the substrates used for coating processes. The particle size and mixing times may be varied to configure the electrode coating layer density and/or roughness.

Furthermore, cathode electrode coating layers may be mixed in step 201, and coated (e.g., onto aluminum), where the electrode coating layer may comprise cathode material mixed with carbon precursor and additive as described above for the anode electrode coating layer. The cathode material may comprise Lithium Nickel Cobalt Manganese Oxide (NMC (also called NCM): LiNiₓCo_{y}Mn_{z}O₂, x+y+z=1), Lithium Iron Phosphate (LFP: LiFePO₄/C), Lithium Nickel Manganese Spinel (LNMO: e.g. LiNi_{0.5}Mn_{1.5}O₄), Lithium Nickel Cobalt Aluminum Oxide (NCA: LiNiₐCo_{b}Al_{c}O₂, a+b+C=1), Lithium Manganese Oxide (LMO: e.g. LiMn₂O₄), a quaternary system of Lithium Nickel Cobalt Manganese Aluminum Oxide (NCMA: e.g. Li[Ni_{0.89}Co_{0.05}Mn_{0.05}Al_{0.01}]O₂, Lithium Cobalt Oxide (LCO: e.g. LiCoO₂), and other Li-rich layer cathodes or similar materials, or combinations thereof. The particle size and mixing times may be varied to configure the electrode coating layer density and/or roughness.

In step 203, the slurry may be coated on a substrate. In this step, the slurry may be coated onto a polyester, polyethylene terephthalate (PET), or Mylar film at a loading of, e.g., 2-4 mg/cm² and then undergo drying in step 205 to an anode coupon with high Si content and less than 15% residual solvent content. This may be followed by an optional calendering process in step 207, where a series of hard pressure rollers may be used to finish the film/substrate into a smooth and denser sheet of material.

In step 209, the active-material-containing film may then be removed from the PET, where the active material layer may be peeled off the polymer substrate. The peeling may be followed by a pyrolysis step 211 where the material may be heated to, e.g., 600-1250° C. for 1-3 hours, cut into sheets, and vacuum dried using a two-stage process (120° C. for 15 h, 220° C. for 5 h). The peeling process may be skipped if polypropylene (PP) substrate is used, and PP can leave ˜2% char residue upon pyrolysis.

In step 213, the electrode material may be laminated on a current collector. For example, a 5-20 μm thick copper foil may be coated with polyamide-imide with a nominal loading of, e.g., 0.2-0.6 mg/cm² (applied as a 6 wt % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

The cell may be assessed before being subject to a formation process. The measurements may comprise impedance values, open circuit voltage, and electrode and cell thickness measurements. The formation cycles are defined as any type of charge/discharge of the cell that is performed to prepare the cell for general cycling and is considered part of the cell production process. Different rates of charge and discharge may be utilized in formation steps. During formation, the initial lithiation of the anode may be performed, followed by delithiation. Cells may be clamped during formation and/or cycling.

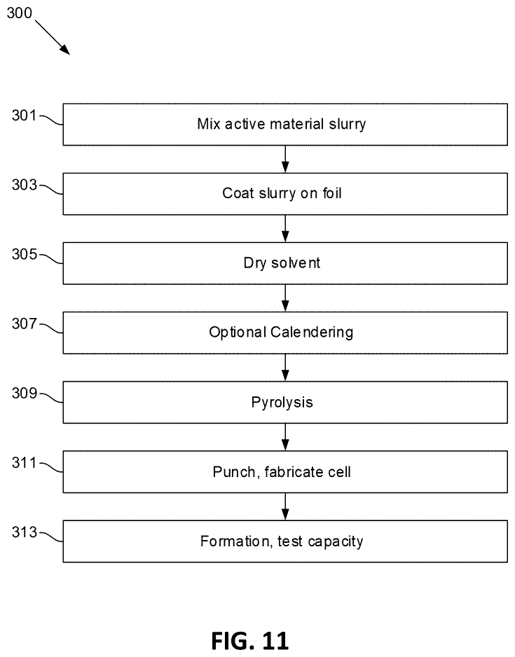

FIG. 11 is a flow diagram of a direct coating process for forming a silicon-dominant anode cell, in accordance with an example embodiment of the disclosure. This process comprises physically mixing the active material, conductive additive, and binder together, and coating the mixed slurry directly on a current collector before pyrolysis. This example process comprises a direct coating process in which an anode or cathode slurry is directly coated on a copper foil using a binder such as CMC, SBR, PAA, Sodium Alginate, PAI, PI and mixtures and combinations thereof.

In step 301, the active material may be mixed with, e.g., a binder/resin (such as PI, PAI or phenolic), solvent (such as NMP, water, other environmentally benign solvents or their mixtures and combinations thereof), and conductive additives. The materials may comprise carbon nanotubes/fibers, graphene sheets, metal polymers, metals, semiconductors, and/or metal oxides, for example. Silicon powder with a 1-30 μm particle size, for example, may then be dispersed in polyamic acid resin, PAI, PI (15% solids in DI water or N-Methyl pyrrolidone (NMP)) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%.

Furthermore, cathode active materials may be mixed in step 301, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 303, the slurry may be coated on a copper foil. In the direct coating process described here, an anode slurry is coated on a current collector with residual solvent followed by a drying and a calendering process for densification. A pyrolysis step (˜500-800° C.) is then applied such that carbon precursors are partially or completely converted into glassy carbon or pyrolytic carbon. Similarly, cathode active materials may be coated on a foil material, such as aluminum, for example. The active material layer may undergo a drying process in step 305 to reduce residual solvent content. An optional calendering process may be utilized in step 307 where a series of hard pressure rollers may be used to finish the film/substrate into a smoother and denser sheet of material. In step 307, the foil and coating optionally proceed through a roll press for calendering where the surface is smoothed out and the thickness is controlled to be thinner and/or more uniform.

In step 309, the active material may be pyrolyzed by heating to 500-1000° C. such that carbon precursors are partially or completely converted into glassy carbon. Pyrolysis can be done either in roll form or after punching. If the electrode is pyrolyzed in a roll form, it will be punched into individual sheets after pyrolysis. The pyrolysis step may result in an anode active material having silicon content greater than or equal to 50% by capacity or by weight. In an example scenario, the anode active material layer may comprise 20 to 95% silicon. In another example scenario may comprise 50 to 95% silicon by weight. In instances where the current collector foil is not pre-punched/pre-perforated, the formed electrode may be perforated with a punching roller, for example. The punched anodes may then be used to assemble a cell with cathode, separator and electrolyte materials. In some instances, separator with significant adhesive properties may be utilized.

In step 313, the cell may be assessed before being subject to a formation process. The measurements may comprise impedance values, open circuit voltage, and cell and/or electrode thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

As used herein, “and/or” means any one or more of the items in the list joined by “and/or”. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will comprise all implementations falling within the scope of the appended claims.

What is claimed is:

1. A battery device, comprising:
a cell, and
a high heat capacity material incorporated into the cell, wherein a total added weight of the high heat capacity material is less than 20% of a weight of the cell.

2. The battery device of claim 1, wherein the cell is one of a lithium ion cell, and a sodium ion cell.

3. The battery device of claim 1, wherein a material, with a change in specific heat capacity of at least 0.5 J/(kg·K²) across any temperature range between 25° C. and 1500° C., is incorporated into the cell.

4. The battery device of claim 1, wherein a specific heat capacity of the high heat capacity material is greater than 1 J/(g·K) at room temperature and ambient pressure conditions.

5. The battery device of claim 1, wherein a specific heat capacity of the high heat capacity material is greater than 2.5 J/(g·K) at room temperature and ambient pressure conditions.

6. The battery device of claim 1, wherein a material, operable to undergo endothermic phase changes, is incorporated into the cell.

7. The battery device of claim 1, wherein a material, operable to undergo endothermic phase reactions, is incorporated into the cell.

8. The battery device of claim 1, wherein a material, with an endothermic enthalpy greater than 500 J/g, is incorporated into the cell.

9. The battery device of claim 1, wherein a material, with an endothermic enthalpy greater than 1,000 J/g, is incorporated into the cell.

10. The battery device of claim 1, wherein a material, with a heat absorption capacity of at least 2,000 J/g at a temperature above 25° C., is incorporated into the cell.

11. The battery device of claim 1, wherein a material, with a heat absorption capacity of at least 2,000 J/g at a temperature below 1,000° C., is incorporated into the cell.

12. The battery device of claim 1, wherein:
a beryllium compound is incorporated into the cell, and
the beryllium compound is one of BeO, BeF2, and Be(OH)2.

13. The battery device of claim 1, wherein:
a lithium compound is incorporated into the cell, and
the lithium compound is one of LiF, Li2O, LiOH, LiOH·H2O, Li2CO3, LiAlO2, and LiAlF4.

14. The battery device of claim 1, wherein:
the cell is a Li-ion cell,
one or more anodes of the cell comprise one or more of:
graphite,
silicon,
lithium,
a silicon/graphite composite, and
a silicon oxide/graphite composite,
a carbon compound is incorporated into the cell, and
the carbon compound comprises one or more of:
graphite,
amorphous hard carbon,
amorphous soft carbon,
expandable graphite,
expanded graphite,
graphene,
fullerenes,
carbon nanotubes,
carbon fibers,
carbon-carbon composites,
a carbonaceous material, and
a carbon allotrope.

15. The battery device of claim 14, wherein a portion of the carbon compound is inactive.

16. The battery device of claim 1, wherein:
the cell is a Na-ion cell, and
one or more of graphite and amorphous carbon are incorporated into the cell.

17. The battery device of claim 1, wherein:
the cell is a Na-ion cell,
an inactive compound is incorporated into the cell, and
the inactive compound comprises one or more of:
graphite,
amorphous hard carbon,
amorphous soft carbon,
graphene,
expanded graphite,
expandable graphite,
intercalated graphite, and
a carbonaceous material.

18. The battery device of claim 1, wherein:
the high heat capacity material is a nonflammable compound, and
the nonflammable compound comprises one or more of:
phosphazene,
an ionic liquid,
a phosphite/phosphate-based solvent,
trimethyl phosphate,
triethyl phosphate,
tris(2,2,2-trifluoroethyl) phosphate,
a high boiling point hydroflouroether,
1,1,2,2-tetrafluoroethyl,
2,2,3,3-tetrafluoropropyl ether,
1,1,2,2-tetrafluoroethyl,
1H,1H,5H-octafluoropentyl ether,
Novec-7300,
Novec-7500,
perfluoroether,
a perfluorocarbon solvent,
a hydrofluorocarbon solvent, and
Al2O3.

19. The battery device of claim 1, wherein:
the high heat capacity material is a nonflammable polymer, and
the nonflammable polymer comprises one or more of:
Teflon (PTFE),
PVDF,
PVC, and
Polyvinylidene chloride.

20. The battery device of claim 1, wherein:
the high heat capacity material is a polymer, and
the polymer comprises one or more of:
rubber,
paraffin wax,
hydrofluorowax,
fluorinated paraffin,
lignin,
furfural,
phenolic resin,
epoxy resin,
a cellulose-based polymer,
PET,
a polyamide,
a polyimide,
PVA,
PEEK,
PEO,
PEG,
an aramid,
polycarbonate,
polyethylene,
polyarylacetylene,
polystyrene,
PAN,
PMMA,
a polypropylene,
a silicone,
Teflon,
PVDF.
PVC,
polyvinylidene chloride,
ammonium polyphosphate (APP),
triphenyl phosphate, and
a brominated flame retardant.
